(19) United States
(12) Patent Application Publication
(10) Pub. No.: US 2024/0095858 A1
(43) Pub. Date: Mar. 21, 2024

(54) SYSTEM AND METHOD FOR GENERATING LIST OF RECOMMENDED COLLEGES

(71) Applicant: Premium Prep LLC, Chapel Hill, NC (US)

(72) Inventor: Cary Levine, Chapel Hill, NC (US)

(21) Appl. No.: 18/472,097

(22) Filed: Sep. 21, 2023

Related U.S. Application Data
(60) Provisional application No. 63/376,488, filed on Sep. 21, 2022.

(51) Int. Cl. G06Q 50/20

(52) U.S. Cl. CPC G06Q 50/2053

(57) ABSTRACT

A system for recommending colleges for students to apply for admission, the system comprises a memory configured to store computer executable instructions and one or more processors configured to execute the instructions to obtain student profile data of a student. Further, obtain college data for each college from a list of colleges. The one or more processors are further configured to determine a college signature for each college of the list of colleges based on the respective college data, using a trained machine learning module. Further, generate a score of admission for each college of the list of colleges for the student, based on a comparison between the student profile data and the respective college signature and generate a list of recommended colleges from the list of colleges for the student using the score of admission corresponding to each college of the list of colleges.

### TECHNOLOGICAL FIELD

The present disclosure generally relates to systems and methods for recommending colleges, and more particularly to systems and methods for recommending colleges to students using a machine learning module.

### BACKGROUND

The college admissions process is complex, and students may be unaware of the elements that influence their acceptance into a college. Colleges have also become critical in selecting students. Therefore, the students may have to apply to multiple colleges at a time to improve chances of enrollment. Each college has a different application procedure, different requirements, and application fees thereby making the process of applying to multiple colleges time-consuming, burdensome, and capital intensive.

Typically, the students may seek recommendations of colleges from a counselor to shortlist a number of colleges providing a good match between parameters required by students and likelihood of acceptance. However, recommending colleges to students is a time-consuming task for a counsellor, thus limiting the number of students a counselor may advise in a limited amount of time. Further, the knowledge of the counsellor may be limited to a few colleges resulting in inefficient guidance of the students.

### SUMMARY

A system and a method are provided herein that focuses on recommending colleges for students to apply for admission and for easing the process of admission.

In one aspect, a method for recommending colleges for students to apply for admission is provided. The method comprises receiving student profile data of a student. The method further comprises obtaining college data associated with each of a plurality of colleges. Further, the method comprises determining, using a trained machine learning module, a college signature for each of the plurality of colleges based on the respective college data, wherein the college signature comprises one or more admission criteria and a weight associated with each of the one or more admission criteria. Further, the method comprises generating, using the trained machine learning module, an admission score corresponding to each of the plurality of colleges for the student, based on a comparison between the student profile data and the college signature for each of the plurality of colleges; and generating a list of recommended colleges for the student based on the admission score of the student corresponding to each of the plurality of colleges.

In additional method embodiments, the student profile data comprises at least one of: an academic performance record of the student, an extracurricular activities record of the student, a list of preferred colleges, or demographic data of the student.

In additional method embodiments, the method further comprises receiving the student profile data of the student through a user interface.

In additional method embodiments, the college data for a college from the plurality of colleges comprises at least one of: college information relating to the college, accepted student profile data, and rejected student profile data.

In additional method embodiments, to determine the college signature for the college from the plurality of colleges, the method further comprises determining one or more admission criteria for the college based on the college data. Further, the method comprises analyzing the accepted student profile data and the rejected student profile data of the college to assign a weight to each of the one or more admission criteria for the college; calculating a weighted admission score for each profile of the accepted student profile data and the rejected student profile data based on the assigned weight for each of the one or more of admission criteria, the accepted student profile data, and the rejected student profile data; and calculating a threshold score for the college based on the weighted admission score of each profile from the accepted student profile data and the rejected student profile data.

In additional method embodiments, to generate the list of recommended colleges for the student, the method further comprises comparing the admission score of the student for the college with the threshold score for the college. Further, the method comprises assigning a category from a plurality of categories to the college for the student based on the comparison and generating the list of recommended colleges for the student based on the assigned category to the college for the student.

In additional method embodiments, to generate the list of recommended colleges for the student, the method further comprises selecting one or more colleges from the plurality of colleges based on an assigned category for each of the plurality of colleges for the student, wherein the category is assigned to each of the plurality of colleges based on a comparison between admission score of the student for the college with corresponding the threshold score for the college and generating the list of recommended colleges for the student based on the selected one or more colleges; and rendering for display the list of recommended colleges for the student and one or more graphical user interface elements selectable by a user to apply for admission.

In additional method embodiments, the plurality of categories indicates a likelihood of admission, and the plurality of categories comprises at least one of: a likely category, a within reach category, and an out of reach category.

In additional method embodiments, to determine the college signature for the college, the method further comprises determining a demographic pattern for the college based on the college data of the college.

In additional method embodiments, to generate the admission score of the student for the college, the method further comprises calculating a student score of the student based on the student profile data and the weight of each of the one or more admission criteria for the college. Further, the method comprises generating the admission score of the student for the college based on an aggregation of the student score for each of the one or more admission criteria for the college.

In additional method embodiments, to generate the admission score of the student for the college, the method further comprises comparing demographic data of the student with the demographic pattern for the college.

In additional method embodiments, to train the machine learning module, the method further comprises obtaining training admissions data, wherein the training admissions data comprises training college data and training student data; processing the training admissions data using the machine learning module, wherein the processing of the training admissions data comprises determining a plurality of training admission criteria, training weights and training student scores; and generating one or more training recommendation lists based on the processing.

In another aspect, a system for recommending colleges for students to apply for admission is provided. The system comprises a memory configured to store computer executable instructions and one or more processors (hereinafter referred as processor) configured to execute the instructions to receive student profile data of a student. The processor is further configured to obtain college data associated with each of a plurality of colleges. Further, the processor is configured to determine, using a trained machine learning module, a college signature for each of the plurality of colleges based on the respective college data, wherein the college signature comprises one or more admission criteria and a weight associated with each of the one or more admission criteria. The processor is further configured to generate, using the trained machine learning module, an admission score corresponding to each of the plurality of colleges for the student, based on a comparison between the student profile data and the college signature for each of the plurality of colleges; and generate a list of recommended colleges for the student based on the admission score of the student corresponding to each of the plurality of colleges.

In additional system embodiments, to determine the college signature for a college from the plurality of colleges, the one or more processors are configured to determine one or more admission criteria for the college based on the college data. The processor is further configured to analyze the accepted student profile data and the rejected student profile data of the college to assign a weight to each of the one or more admission criteria for the college. Further, the processor is configured to calculate a weighted admission score for each profile of the accepted student profile data and the rejected student profile data based on the assigned weight for each of the one or more of admission criteria, the accepted student profile data, and the rejected student profile data; and calculate a threshold score for the college based on the weighted admission score of each profile from the accepted student profile data and the rejected student profile data.

In additional system embodiments, to generate the list of recommended colleges for the student, the one or more processors are configured to compare the admission score of the student for the college with the threshold score for the college. The processor is further configured to assign a category from a plurality of categories to the college for the student based on the comparison and generate the list of recommended colleges for the student based on the assigned category to the college for the student.

In additional system embodiments, to generate the list of recommended colleges for the student, the one or more processors are configured to select one or more colleges from the plurality of colleges based on an assigned category for each of the plurality of colleges for the student, wherein the category is assigned to each of the plurality of colleges based on a comparison between admission score of the student for the college with corresponding the threshold score for the college; and generate the list of recommended colleges for the student based on the selected one or more colleges and render for display the list of recommended colleges for the student and one or more graphical user interface elements selectable by a user to apply for admission.

In additional system embodiments, to generate the admission score of the student for the college, the one or more processors are configured to calculate a student score of the student based on the student profile data and the weight of each of the one or more admission criteria for the college. The processor is further configured to generate the admission score of the student for the college based on an aggregation of the student score for each of the one or more admission criteria for the college.

In additional system embodiments, to train the machine learning module, the one or more processors are configured to obtain training admissions data, wherein the training admissions data comprises training college data and training student data. The processor is further configured to process the training admissions data using the machine learning module, wherein the processing of the training admissions data comprises determining a plurality of training admission criteria, training weights and training student scores; and generate one or more training recommendation lists based on the processing.

In yet another aspect, a computer programmable product comprising a non-transitory computer readable medium having stored thereon computer executable instructions, which when executed by one or more processors, cause the one or more processors to carry out operations comprising receiving student profile data of a student. The operations comprise obtaining college data associated with each of a plurality of colleges. The operations comprise determining, using a trained machine learning module, a college signature for each of the plurality of colleges based on the respective college data, wherein the college signature comprises one or more admission criteria and a weight associated with each of the one or more admission criteria. The operations comprise generating, using the trained machine learning module, an admission score corresponding to each of the plurality of colleges for the student, based on a comparison between the student profile data and the college signature for each of the plurality of colleges and generating a list of recommended colleges for the student based on the admission score of the student corresponding to each of the plurality of colleges.

In additional computer program product embodiments, the operations further comprise determining one or more admission criteria for the college based on the college data. The operations comprise analyzing the accepted student profile data and the rejected student profile data of the college to assign a weight to each of the one or more admission criteria for the college. The operations comprise calculating a weighted admission score for each profile of the accepted student profile data and the rejected student profile data based on the assigned weight for each of the one or more of admission criteria, the accepted student profile data, and the rejected student profile data and calculating a threshold score for the college, based on the weighted admission score of each profile from the accepted student profile data and the rejected student profile data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a network environment in which a system for recommending colleges to students is implemented, in accordance with an embodiment of the present disclosure;

FIG. 2 illustrates a block diagram of the system for recommending colleges to students, in accordance with an embodiment of the present disclosure;

FIG. 3 illustrates an example of deployment of the system for recommending colleges to students, in accordance with an embodiment of the present disclosure;

FIG. 4 illustrates a flow chart of a method for determining a college signature for a college, in accordance with an embodiment of the present disclosure;

FIG. 5 illustrates a flow diagram of a method for generating an admission score of a student for the college, in accordance with an embodiment of the present disclosure;

FIG. 6 illustrates a method for generating a list of recommended colleges for the student, in accordance with an embodiment of the present disclosure; and

FIG. 7 illustrates a method for training a machine learning module, in accordance with an embodiment of the present disclosure.

### DETAILED DESCRIPTION

In the following description, for purposes of explanation, numerous specific details are set forth in order to provide a thorough understanding of the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not others.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

As will be appreciated by one skilled in the art, the aspects of the present invention may be embodied as a system, a method, or a computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “engine,” “module,” or “system.” Furthermore, aspects of the present invention may take the form of a computer program product embodied in one or more computer readable medium(s) having computer readable program code embodied thereon.

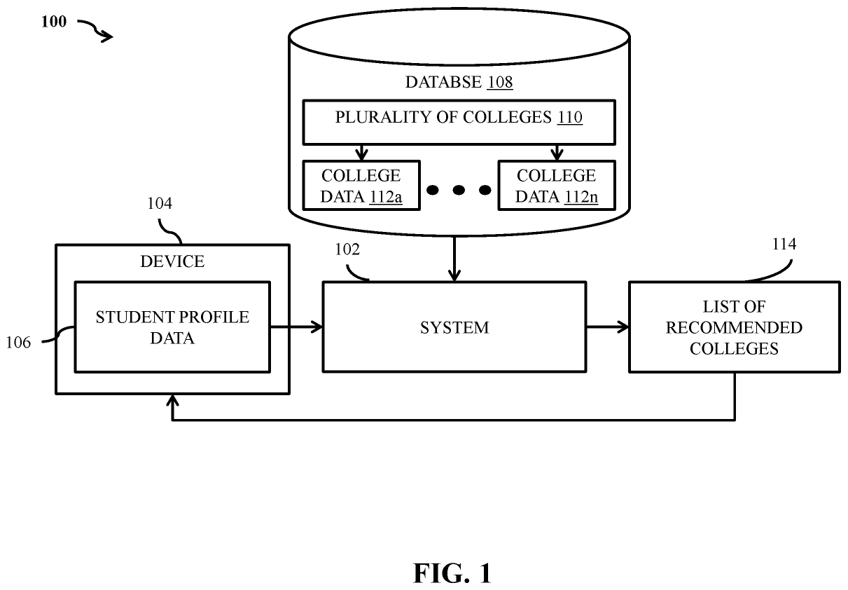

FIG. 1 illustrates a network environment 100 in which a system 102 for recommending colleges for students is implemented, in accordance with an example embodiment. The network environment 100 comprises the system 102, a device 104, a student profile data 106, a database 108, a plurality of colleges 110, a college data 112a to a college data 112n (collectively, the college data 112), and a list of recommended colleges 114.

In operation, the system 102 may be configured to receive the student profile data 106 of a student. In one exemplary embodiment, the student profile data 106 may be received from the student through the device 104. The device 104 may include, but not limited to, a portable computer, a personal digital assistant, a handheld device, and a workstation. The device 104 may be equipped with a user interface, which may allow the student to enter, edit, and organize the student profile data 106. Further, the system 102 may receive the student profile data 106 through the user interface of the device 104.

The student profile data 106 may comprise an academic performance record of the student, an extracurricular activities record of the student, demographic data, and a list of preferred colleges of the student. The academic performance record of the student profile data 106 provides information about the student's academic achievements and capabilities. The academic performance record may include a record of the student's courses, grades, and overall grade point average (GPA). The academic performance record may also include scores from standardized tests such as SAT, ACT, GRE, or other relevant exams. Further, the academic performance record of the student may also include a rank of the student in his/her graduating class. Moreover, the academic performance record may also include information relating to recognition for exceptional academic achievements, scholarships, or academic honor. The extracurricular activities record of the student profile data 106 provides the student's involvement in extracurricular and co-curricular activities, which demonstrates their interests, leadership, and engagement outside of academics. The demographic data of the student profile data 106 provides essential personal information about the student such as name and contact information, date of birth, gender, race, residency status and the like. The list of preferred colleges of the student profile data 106 provides information relating to colleges or universities in which the student may be interested to apply for admission.

Further, the system 102 may be configured to obtain college data 112 associated with each of the plurality of colleges 110. The plurality of colleges 110 may be at least one of a pre-stored list of colleges, stored in the database 108 or the list of preferred colleges of the student profile data 106. The college data 112 may comprise at least one of college information relating to the college, accepted student profile data and rejected student profile data. The accepted student profile data and the rejected student profile data may be profiles of the students previously accepted by the college and rejected by the college. The college information may comprise information such as academic programs offered by a college, admission criteria of the college, past admission statics including an acceptance rate, geographic location of the college, campus facilities provided by the college, safety and security status of the college, worldwide ranking, tuition fees and courses offered by the college, financial aid statistics of the college, student demographics of a students studying in the college, student to faculty ratio of the college, a percentage of students who graduate within a specific timeframe, information on post-graduation employment rates, and the like. The accepted student profile and the rejected student profile may comprise information relating to academic performance, extracurricular performance, and demographic details of the students who were either accepted or rejected. The demographic details may comprise at least one of age, race, sex, and the like of the student.

Further, the system 102 may be configured to determine, using a trained machine learning module 202b, a college signature for each of the plurality of colleges 110 based on the respective college data 112, wherein the college signature comprises one or more admission criteria and a weight associated with each of the one or more admission criteria. The college signature represents a distinctive eligibility requirements and characteristics for a particular college of the list of colleges 110.

Further, the system 102 may be configured to generate, using the trained machine learning module 202b, an admission score corresponding to each of the plurality of colleges 110 for the student, based on a comparison between the student profile data 106 and the college signature for each of the plurality of colleges 110. The admission score for a college of the plurality of colleges 110 may indicate how well the student profile data 106 of the student aligns with the distinct requirements and the characteristics of the college of the list of colleges 110.

Further, the system 202 may be configured to generate the list of recommended colleges 114 for the student based on the admission score of the student corresponding to each of the plurality of colleges 110. The list of recommended colleges 114 may be provided to the student through the device 104, wherein the device 104 may be equipped with the user interface. The user interface of device 104 may render for display, the list of recommended colleges 114 selectable by the student to apply for admission.

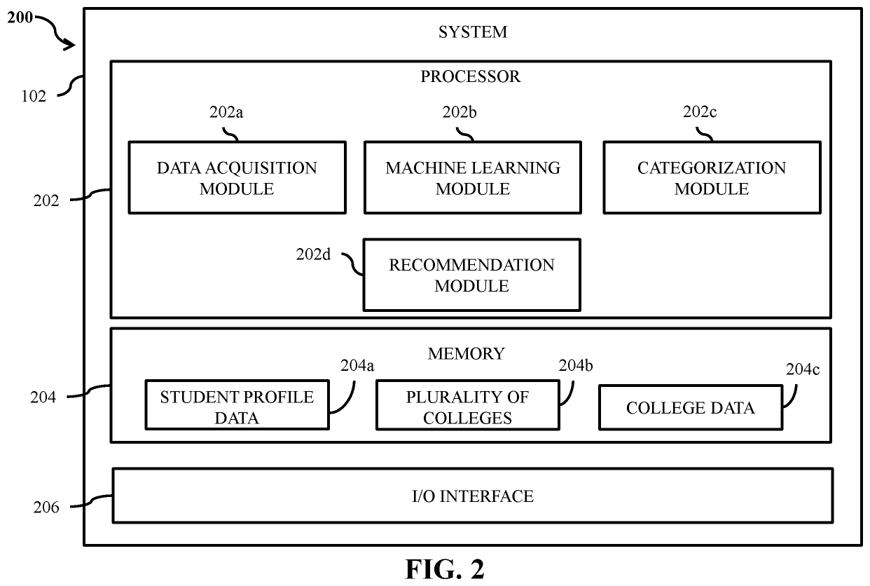

FIG. 2 illustrates a block diagram 200 of the system 102 for recommending colleges to students to apply for admission, in accordance with an embodiment of the present disclosure. FIG. 2 is explained in conjunction with FIG. 1.

The system 102 may include one or more processors 202 (referred to as a processor 202, hereinafter), a memory 204, and an I/O interface 206. The processor 202 may comprise a data acquisition module 202a, a machine learning module 202b, a categorization module 202c, and a recommendation module 202d.

In accordance with an embodiment, the system 102 may store data that may be generated by the processor 202 while performing corresponding operation or may be retrieved from a database 108 associated with the system 102, such as from the memory 204. In an example, the data may include the student profile data, the plurality of colleges and the college data.

The memory 204 of the system 102 may be configured to store a dataset (such as, but not limited to, the student profile data 204a, the plurality of colleges 204b and the college data 204c).

In operation, the processor 202 may configure the data acquisition module 202a to extract the plurality of colleges 110 from one or more college data repositories. To check fulfillment of eligibility criteria, the system 102 may extract the college data 112 for each of the plurality of colleges 110 by scraping or crawling the one or more college data repositories using the data acquisition module 202a. The data acquisition module 202a may use APIs of the college data repositories to obtain the college data 112 associated with each of the plurality of colleges 110.

Further, the processor 202 may configure the machine learning module 202b to determine the college signature for each of the plurality of colleges 110. The college signature may correspond to eligibility criteria of a college. The college signature may comprise an accepted signature and a rejected signature for each of the plurality of colleges 110 based on the respective college data 112. The accepted signature may comprise a threshold weighted score for being accepted and a demographic pattern based on the demographic details from the accepted student profiles. The rejected signature may comprise a threshold weighted score for being rejected and a demographic pattern based on the demographic data of the rejected student profiles.

Further, the processor 202 may configure the categorization module 202c to assign categories to each of the plurality of colleges 110 for the student. The categorization module 202c may assign a category to a college for the student based on a comparison between the student profile data 106 and the threshold weighted score of the college.

Further, the processor 202 may configure the recommendation module 202d to select one or more colleges from the plurality of colleges 110 for the student based on the categories assigned to each college of the plurality of colleges 110. It may be noted that a preferred colleges of the preferred list of colleges may be given a higher preference than the colleges of the pre-store list of colleges.

In an example, the processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

In an example, when the processor 202 is embodied as an executor of software instructions, the instructions may specifically configure the processor 202 to perform the algorithms and/or operations described herein when the instructions are executed. However, in some cases, the processor 202 may be a processor specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU) and logic gates configured to support operation of the processor 202. The network environment, such as the network environment 100 may be accessed using the communication interface 206 of the system 102. The communication interface 206 may provide an interface for accessing various features and data stored in the system 102.

Additionally, or alternatively, the processor 202 may include one or more processors capable of processing large volumes of workloads and operations to provide support for analysis of the college data 112 and evaluation of the college signature, and the student profile data 106. In an example embodiment, the processor 202 may be in communication with the memory 204 via a bus for passing information among components coupled to the system 102. In another embodiment, the processor 202 may also be connected via a networking mechanism to one or more virtual machine processors which are physically remote to enable cloud-based computing to assist with data processing, evaluation, application of artificial intelligence, rules based analysis, and the like. These virtual machines extend the local processing into the cloud seamlessly for additional computing power on-demand, or as scheduled.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an ASIC, FPGA or the like, the processor 202 may be specifically configured hardware for conducting the operations described herein.

In some example embodiments, the I/O interface 206 may communicate with the system 102 and displays input and/or output of the system 102. As such, the I/O interface 206 may include a display and, in some embodiments, may also include a keyboard, a mouse, a joystick, a touch screen, touch areas, soft keys, one or more microphones, a plurality of speakers, or other input/output mechanisms. In one embodiment, the system 102 may comprise user interface circuitry configured to control at least some functions of one or more I/O interface elements such as a display and, in some embodiments, a plurality of speakers, a ringer, one or more microphones and/or the like. The processor 202 and/or I/O interface 206 circuitry comprising the processor 202 may be configured to control one or more functions of one or more I/O interface 206 elements through computer program instructions (for example, software and/or firmware) stored on a memory 204 accessible to the processor 202. The processor 202 may further render notification associated with the recommended enhancements, such as reminders of medicines, tests to be performed, use of any appliance or equipment for ease or accessibility, personalized recommendations, etc., on a user equipment or audio or display associated with the occupant 104 via the I/O interface 206.

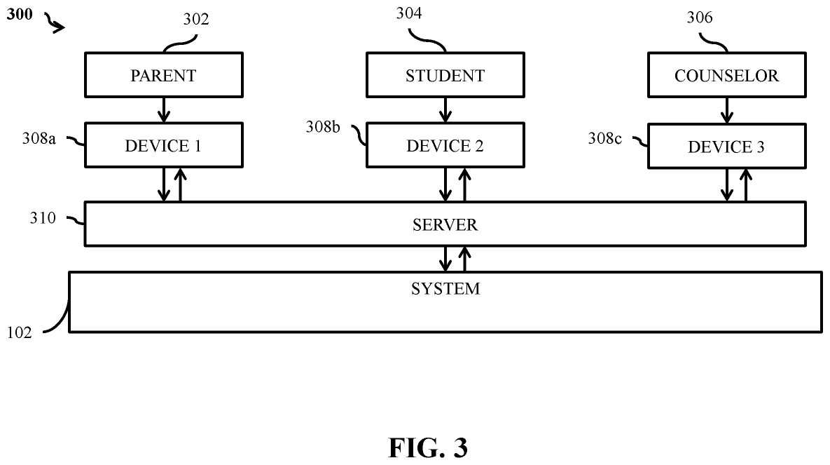

FIG. 3 illustrates an example deployment 300 of the system 102 for recommending colleges to students, in accordance with an embodiment of the present disclosure.

The system 102, such as a user interface of the system may be accessed by a parent 302 of a student 304, the student 304, and a counselor 306 using a device 308a, device 308b and device 308c, respectively. In an embodiment, the student profile data 106 may be received from the student 304 and/or the parent 302. The student 304 or parent 302 may login to system 102 using the device 308a or 308b, respectively, and submit information regarding the student profile data 106. The counselor 306 may access the system 102 to recommend one or more colleges for the student 304. In one embodiment, a number of counselors may use the system 102 to generate the list of recommended collages 114 for different students.

It may be noted that one or more users may access the system 102 through one or more devices 308a, 308b, and 308c, collectively referred to as devices 308, hereinafter, or applications residing on the devices 308a, 308b, and 308c.

Although the present disclosure is explained considering that the system 102 may implemented on a server 310, it may be understood that the system 102 may be implemented in a variety of computing systems, such as a laptop computer, a desktop computer, a notebook, a workstation, a virtual environment, a mainframe computer, a server, a network server, a cloud-based computing environment. It will be understood that the system 102 may be accessed by multiple users through one or more devices. In one implementation, the system 102 may comprise the cloud-based computing environment in which the user may operate individual computing systems configured to execute remotely located applications. Examples of the user devices may include, but are not limited to, a portable computer, a personal digital assistant, a handheld device, and a workstation. The user devices are communicatively coupled to the system 102 through a communications network.

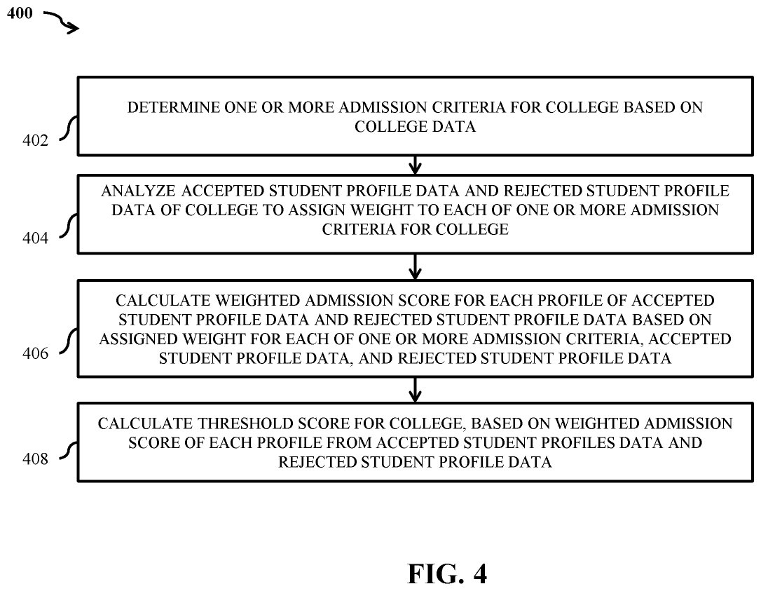

FIG. 4 illustrates a flow chart of method 400 for determining the college signature for a college from the plurality of colleges 110, in accordance with an embodiment of the present disclosure.

The steps of the method 400 for determining the college signature for the college of the plurality of colleges 110 may be performed using the machine learning module 202b of the system 102.

At 402, one or more admission criteria are determined for the college based on the college data. The college data 112 may comprise the college information relating to the college, the accepted student profile data, and the rejected student profile data. Consider an example, the accepted student profile data of the college may be as shown in Table A1 and the rejected student profile data of the college may be as shown in Table A2. Continuing with the present example, each profile of the accepted student profile data and the rejected student profile data, scored out of one hundred for one or more admission criteria and the demographic data of each profile comprise their nationality. The machine learning module 202b, using the college data 112, may determine the one or more admission criteria for the college such as admission criterion A—Academics, admission criterion B—Sports, admission criterion C—Social work.

TABLE A1
Accepted Student Profile data of the College

| | admission | admission | Admission | demographic |
|---|---|---|---|---|
| | criterion A | criterion B | criterion C | details |
| student | 80 | 50 | 60 | Indian |
| profile A | | | | |
| student | 75 | 40 | 80 | American |
| profile B | | | | |
| student | 90 | 20 | 65 | Indian |
| profile C | | | | |
| student | 85 | 45 | 60 | Chinese |
| profile D | | | | |

TABLE A2
Rejected Student Profile data of College

| | | | | Demographic |
|---|---|---|---|---|
| | Criterion A | Criterion B | Criterion C | Details |
| student | 50 | 50 | 60 | Chinese |
| profile E | | | | |
| student | 60 | 50 | 40 | Brazilian |
| profile F | | | | |
| student | 70 | 60 | 20 | Brazilian |
| profile G | | | | |
| student | 60 | 50 | 60 | Chinese |
| profile H | | | | |

At 404, the accepted student profile data and the rejected student profile data of the college are analyzed to assign a weight to each of the one or more admission criteria for the college. In one embodiment, the machine learning module 202b may assign the weight to each of the one or more admission criteria by determining the past admission statics using the accepted student profile data and the rejected student profile data of the college. Continuing with the present example, the weights assigned to each of the one or more admission criteria are as shown in Table B.

TABLE B

| | |
|---|---|
| Academics | 44% |
| Sports | 21% |
| Social Work | 35% |

At 406, a weighted admission score for each profile of the accepted student profile data and the rejected student profile data is calculated based on the assigned weight for each of the one or more of admission criteria, the accepted student profile data, and the rejected student profile data. The machine learning module 202b may calculate the weighted admission score for each profile based on the weights assigned to the one or more admission criteria and scores of respective profiles in each admission criteria. Continuing with the present example, scores of a profile in each admission criteria are ‘x’, ‘y’, ‘z’ and the weights assigned to each admission criteria are ‘n1%’, ‘n2%’, ‘n3%’. The weighted admission score of the profile may be equal to [(x*n1%)+(y*n2%)+(z*n3%)].

Continuing with the present example, the weighted admission score of each profile from the accepted student profile data and the weighted admission score of each profile from the rejected student profile data are as shown in Table C1, Table C2, respectively.

TABLE C1

| | |
|---|---|
| student profile A | 66.7 |
| student profile B | 69.4 |
| student profile C | 66.5 |
| student profile D | 67.83 |

TABLE C2

| | |
|---|---|
| student profile E | 53.5 |
| student profile F | 50.9 |
| student profile G | 50.4 |
| student profile H | 57.9 |

At 408, a threshold score for the college is calculated based on the weighted admission score of each profile from the accepted student profile data and the rejected student profile data. The machine learning module 202b may calculate the threshold score for the college based on the weighted admission score of each profile from the accepted student profile data and the weighted admission score of each profile from the rejected student profile data. In one embodiment, the threshold score may be calculated using at least one of a binary classification technique (accepted/rejected), or a linear or non-linear regression technique. Continuing with the present example, the threshold score of acceptance is 66.5 and the threshold weighted score of rejection is 57.9.

In one embodiment, the machine learning module 202b may further determine a demographic pattern for the college based on the college data 112 of the college. Continuing with the present example, the demographic pattern for the college is as follows: African American—10% accepted, Indian—90% accepted, American—99% accepted, Chinese—33% accepted.

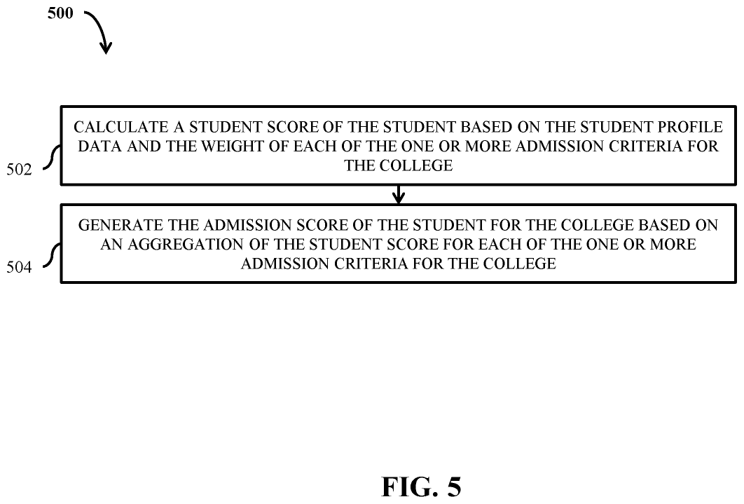

FIG. 5 illustrates a flow diagram of a method 500 for generating the admission score for a college from the plurality of colleges 110, in accordance with an embodiment of the present disclosure.

The steps of the method 500 for generating the admission score for the college from the plurality of colleges 110 may be performed using the categorization module 202c of the system 102.

At 502, a student score of the student is calculated based on the student profile data 106 and the weight of each of the one or more admission criteria for the college. The categorization module 202c may calculate the student score of the student for the college, by comparing the student profile data 106 of the student with the college signatures of the college. In one embodiment the college may be comprised by the list of preferred colleges from the student profile data 106 and/or the pre-stored list of colleges. The categorization module 202c may obtain scores of the student for the one or more admission criteria from the student profile data 106. Similarly, the categorization module 202c may obtain the weights assigned to each of the one or more admission criteria from the college signature of the college. In an example, if scores of the student in each of the one or more admission criteria are ‘a’, ‘13’, ‘c’ and the weights assigned to each of the one or more admission criteria of the college are ‘n1%’, ‘n2%’, ‘n3%’, the student score for each of the one or more admission criteria may calculated as student score for admission criteria ‘a’ equal to (a*n1%), student score for admission criteria ‘b’ equal to (2*n2%), student score for admission criteria ‘c’ equal to (c*n3%).

At 504, the admission score of the student for the college is generated based on an aggregation of the student score for each of the one or more admission criteria for the college. Continuing with the present example, the admission score of the student for the college may be calculated by aggregating student scores as [(a*n1%)+(b*n2%)+(c*n3%)]. Consider another example, if scores of the student for one or more admission criteria are ‘Academics—80’, ‘Sports—50’, ‘Social work—60’ and the weights assigned to each of the one or more admission criteria of the college are ‘44%’, ‘21%’, ‘35%’, the student score for each of the one or more admission criteria may calculated as student score for admission criteria ‘Academics’ equal to (80*0.44), student score for admission criteria ‘Sports’ equal to (50*0.21), and student score for admission criteria ‘Social work’ equals to (60*0.35). Further, the admission score of the student may be calculated by aggregating the student score as [(80*0.44)+(50*0.21)+(60*0.35)]. Accordingly, the calculated admission score for the present example is equal to 66.7.

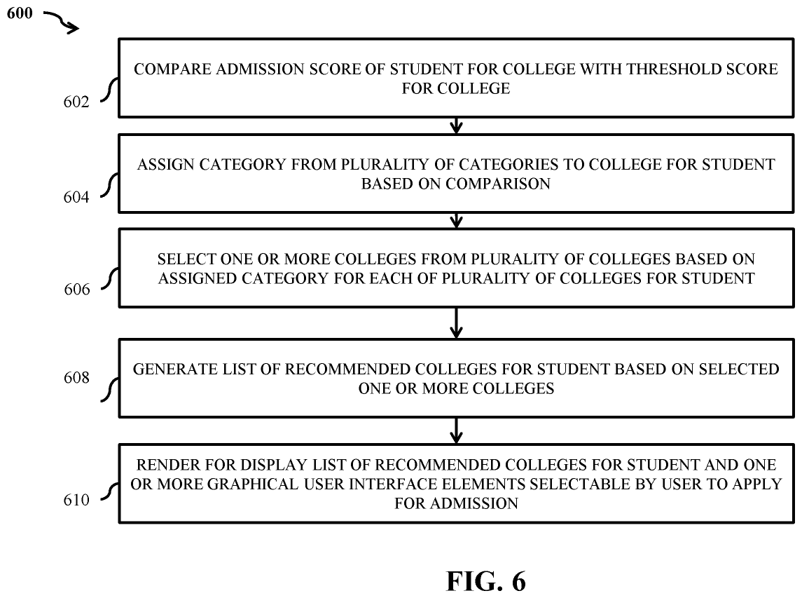

FIG. 6 illustrates a method 600 for generating the list of recommended colleges 114 from the plurality of colleges 110, in accordance with an embodiment of the present disclosure.

The steps of the method 600 for generating the list of recommended colleges 114 from the plurality of colleges 110 may be performed using the categorization module 202c, and the recommendation module 202d of the system 102.

At 602, the admission score of the student for the college is compared with the threshold score for the college. The categorization module 202c may calculate the admission weighted score for the college based on the comparison between the admission score of the student and the threshold score of the college. For example, considering the admission score of the student is 58% and the threshold score of the college is 80%, the categorization module 202c may calculate, using the machine learning module 202b, the admission weighted score for the college as equal to 72.5%. In one embodiment, the demographic data of the student may be compared with the demographic pattern of acceptance of the college.

At 604, a category from a plurality of categories is assigned to the college for the student based on the comparison. In an embodiment, the categorization module 202c may categorize the college within the plurality of categories, wherein the plurality of categories may comprise at least one of (a) likely category, (b) out of reach category, and (c) within reach category. In one embodiment, colleges with the admission weighted score between 70% and 90% may be categorized as likely, the colleges with the admission weighted score between 50% and 70% may be categorized as out of reach, and the colleges with the admission weighted score between 90% and 100% may be categorized as within reach. Continuing with the present example, as the admission weighted score for the college is 72.5%, the categorization module 202c may tag the college as a likely college for the student.

At 606, one or more colleges from the plurality of colleges 110 are selected based on an assigned category for each of the plurality of colleges 110 for the student. For example, the category is assigned to each of the plurality of colleges 110 based on a comparison between admission score of the student for the college with corresponding the threshold score for the college. In order to select the one or more colleges from the plurality of colleges 110, the recommendation module 202d may perform ordering each college from the plurality of colleges 110 in a sequence based on at least one of the admission weighted scores and the worldwide ranking of each of the plurality of colleges 110. In one embodiment, worldwide rankings of each of the plurality of colleges 110 may be acquired using the acquisition module 202a and further the recommendation module 202d may order the each of the plurality of colleges 110, based on the worldwide rankings of the each of the plurality of colleges 110. In another embodiment, the machine learning module 202b may calculate the worldwide rankings of each of the plurality of colleges 110 and further the recommendation module 202d may order the each of the plurality of colleges 110, based on the worldwide rankings of the each of the plurality of colleges 110. In an example embodiment, the recommendation module 202d may order each of the plurality of colleges 110 based on the admission weighted scores of each of the plurality of colleges 110.

At 608, the list of recommended colleges 114 is generated for the student based on the selected one or more colleges. The recommendation module 202d may further generate the list of recommended colleges 114 using the selected one or more colleges to recommend for the student based on the categories assigned to the one or more colleges. The selected one or more colleges may be assigned at least one of the categories ‘likely’ and ‘within reach’. In an example, the plurality of colleges 110 may comprise N colleges. The categorization module 202c may assign a category to each of N colleges for the student. Let us assume N is equal to one thousand, number of colleges assigned the category ‘likely’ is equal to 100, number of colleges assigned the category ‘within reach’ is equal to 200 and the number of colleges assigned the category ‘out of reach’ is equal to 700. In an example, the recommendation nodule 202d may recommend 10 colleges to the student from each of the ‘likely’ and ‘within reach’ based on the admission weighted score of each of the N colleges for the student. The top 10 colleges having the highest admission weighted score from the 100 ‘likely’ and the top 10 colleges from the 200 ‘within reach’ may be recommended for the student. In another example, the recommendation module 202d may recommend 5 colleges from the ‘likely’ and 10 colleges from the ‘within reach’ based on the worldwide ranking of the colleges.

At 610, the list of recommended colleges for the student is rendered for display. In an example, one or more graphical user interface elements selectable by a user to apply for admission may also be rendered with the list of recommended colleges. For example, the student may click on a graphical user interface element associated with a college from the list of recommended colleges to navigate to a website of the college or navigate to an admission portal of the college. The list of recommended colleges 114 may be displayed, as recommended colleges, on a user interface. The user interface may comprise elements for at least one of applying to the list of recommended colleges 114, requesting for more colleges for the list of recommended colleges 114, and displaying the list of recommended colleges 114 of another student.

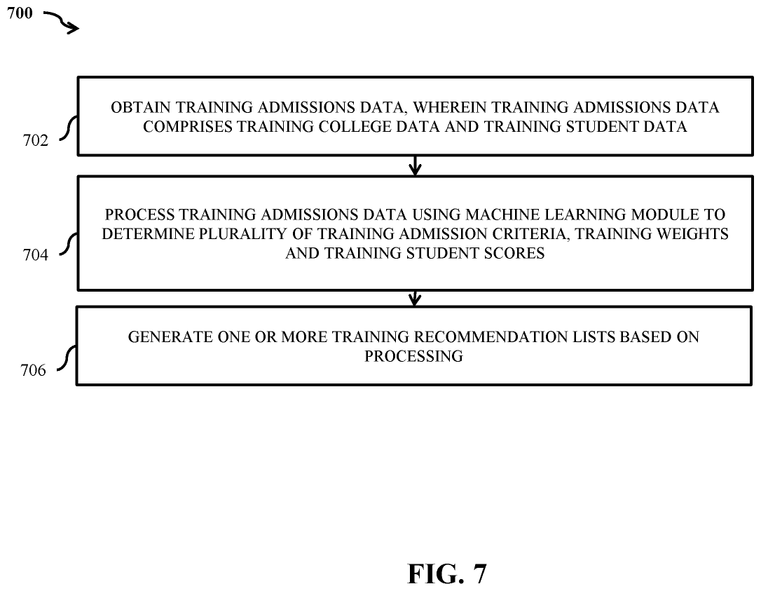

FIG. 7 illustrates a method 700 for training the machine learning module 202b, in accordance with an embodiment of the present disclosure.

The steps of the method 700 for training the machine learning module 202b may be performed using the system 102.

At 702, obtaining training admissions data, wherein the training admissions data comprises training college data and training student data. In one embodiment, the machine learning module 202b may be trained using at least one of a supervised learning method, an unsupervised learning method, and a reinforcement learning method. It may be trained on the training admission data. The training admissions data for training the machine learning module 202b, using supervised learning, may comprise the training college data of the list of colleges. The admission training data for training the machine learning module 202b, using unsupervised learning, may comprise the training college data of the list of colleges and the techniques like K-means clustering, KNN (k-nearest neighbors), hierarchal clustering, anomaly detection, neural networks may be used for training.

At 704, processing the training admissions data using the machine learning module, wherein the processing of the training admissions data comprises determining a plurality of training admission criteria, training weights and training student scores. The trained machine learning module 202b may process the training admission data to determine the plurality of training admission criteria, the training weights, and the training student scores. For example, the machine learning module 202b may analyze the accepted student profile data and the rejected student profile data to determine the college signature for college A by calculating the threshold score and the demographic pattern for college A. To calculate the threshold score, the machine learning module 202d may determine the one or more admission criteria, considered by the college A, to evaluate students and calculate weights assigned to each admission criteria by the college A.

Consider another example, the counselor may be advising student A. The student profile data 106 may be as shown in Table F.

TABLE F

| | | | | | List of |
|---|---|---|---|---|---|
| | Criterion | Criterion | Criterion | | preferred |
| | A | B | C | Demography | colleges |
| Student A | 80 | 50 | 60 | Indian | N.A. |

Scores of the student A for each admission criteria of one or more admission criteria may correspond to, for example, the academic performance of the student A and the extracurricular performance of the student A.

The plurality of colleges 110, weights assigned to each admission criteria of one or more admission criteria by the plurality of colleges 110 and the college signatures may be as shown in Table G.

TABLE G

| | Weights per | College Signatures | |
|---|---|---|---|
| Plurality | admission | Threshold | |
| of colleges | criteria | score | Demographic Pattern |
| College A | Criterion A - 60% | 80 | African American - 10% |
| | Criterion B - 20% | | accepted, |
| | Criterion C - 20% | | Indian - 90% accepted, |
| | | | American - 99% accepted, |
| | | | Chinese - 33% accepted |
| College B | Criterion A - 60% | 90 | African American - 60% |
| | Criterion B - 10% | | accepted, |
| | Criterion C - 30% | | Indian - 50% accepted, |
| | | | American - 99% accepted, |
| | | | Chinese - 40% accepted |
| College C | Criterion A - 30% | 60 | African American - 10% |
| | Criterion B - 50% | | accepted, |
| | Criterion C - 20% | | Indian - 30% accepted, |
| | | | American - 40% accepted, |
| | | | Chinese - 80% accepted |
| College D | Criterion A - 50% | 30 | African American - 90% |
| | Criterion B - 20% | | accepted, |
| | Criterion C - 30% | | Indian - 60% accepted, |
| | | | American - 70% accepted, |
| | | | Chinese - 60% accepted |

The machine learning module 202b may calculate admission score of the student A for each of the plurality of colleges 110. Let us assume that the admission score is as shown in Table H.

TABLE H

| | College A | College B | College C | College D |
|---|---|---|---|---|
| Student A | 58 | 62 | 43 | 67 |

Further, the machine learning module 202b may compare the student A's admission score for each of the plurality of colleges 110 and demographic data with college signature of each of the plurality of colleges 110 to calculate the admission weighted score of the student A in each of the plurality of colleges 110. Let us assume that the admission weighted score of the student A in each college is as shown in Table I.

TABLE I

| College A | College B | College C | College D |
|---|---|---|---|
| 72.5 | 68.8 | 71.6 | 100 |

The categorization module 202c may assign categories to each of the plurality of colleges 110 based on the admission weighted score of the student A. Let us assume that the categories assigned to each of the plurality of colleges 110 for the student A are as shown in Table J.

TABLE J

| College A | College B | College C | College D |
|---|---|---|---|
| Likely | Out of reach | Likely | within reach |

At 706, based on the processing, generating one or more training recommendation lists. Continuing with the present example, the machine learning module 202d may further determine one or more colleges to recommend for the student based on the categories assigned to each of the plurality of colleges 110 to generate the one or more training recommendation lists.

The plurality of training admission criteria, the training weights and the training student scores determined for each college of the plurality of colleges 110 may be compared with plurality of training admission criteria, training weights and training student scores to compute an accuracy of the machine learning module 202b. The machine learning module 202b may be retrained based on the accuracy when the accuracy is below a preset threshold for reinforcement learning. In one embodiment, a counselor may analyze the determined one or more admission criteria and the threshold weighted score to provide feedback about accuracy of the machine learning module 202b. The feedback is used as the training admission data to retrain the machine learning module 202b using at least one of Q-learning, SARSA, DQN, DDPG and alike.

In another embodiment, the machine learning module 202b may be trained using Euclidean Distance theorem. The student profiles and the college signatures may be plotted as vectors in a 3D space. The Euclidean distance between a student profile vector and a college signature vector may be equal to the score of admission of the student in the college.

Exemplary embodiments discussed above may provide certain advantages. Though not required to practice aspects of the disclosure, these advantages may include the following.

In some embodiments, a student or parent may save time, money, and effort.

In some embodiments, a counselor may advise a greater number of students simultaneously.

Furthermore, as used in this specification of this application, the terms “computer,” “server,” “processor,” and “memory” all refer to electronic or other technological devices. These terms exclude people or groups of people. For the purposes of the specification, the terms display or displaying means displaying on an electronic device.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples, and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method, implemented by a computing device comprising at least one processor and at least one memory coupled to the at least one processor, comprising:
receiving student profile data of a student;
obtaining college data associated with each of a plurality of colleges;
determining, using a trained machine learning module, a college signature for each of the plurality of colleges based on the respective college data, wherein the college signature comprises one or more admission criteria and a weight associated with each of the one or more admission criteria;
generating, using the trained machine learning module, an admission score corresponding to each of the plurality of colleges for the student, based on a comparison between the student profile data and the college signature for each of the plurality of colleges; and
generating a list of recommended colleges for the student based on the admission score of the student corresponding to each of the plurality of colleges.

2. The method of claim 1, wherein the student profile data comprises at least one of: an academic performance record of the student, an extracurricular activities record of the student, a list of preferred colleges, or demographic data of the student.

3. The method of claim 1, further comprising:
receiving the student profile data of the student through a user interface.

4. The method of claim 1, wherein the college data for a college from the plurality of colleges comprises at least one of: college information relating to the college, accepted student profile data, and rejected student profile data.

5. The method of claim 4, wherein determining the college signature for the college from the plurality of colleges comprises:
determining one or more admission criteria for the college based on the college data;
analyzing the accepted student profile data and the rejected student profile data of the college to assign a weight to each of the one or more admission criteria for the college;
calculating a weighted admission score bar each profile of the accepted student profile data and the rejected student profile data based on the assigned weight for each of the one or more of admission criteria, the accepted student profile data, and the rejected student profile data; and
calculating a threshold score for the college, based on the weighted admission score of each profile from the accepted student profile data and the rejected student profile data.

6. The method of claim 5, wherein generating the list of recommended colleges for the student comprises:
comparing the admission score of the student for the college with the threshold score for the college;
assigning a category from a plurality of categories to the college for the student based on the comparison; and
generating the list of recommended colleges for the student based on the assigned category to the college for the student.

7. The method of claim 6, wherein generating the list of recommended colleges for the student comprises:
selecting one or more colleges from the plurality of colleges based on an assigned category for each of the plurality of colleges for the student, wherein the category is assigned to each of the plurality of colleges based on a comparison between admission score of the student for the college with corresponding the threshold score for the college; and
generating the list of recommended colleges for the student based on the selected one or more colleges; and
rendering for display the list of recommended colleges for the student and one or more graphical user interface elements selectable by a user to apply for admission.

8. The method of claim 6, wherein plurality of categories indicates a likelihood of admission, and wherein the plurality of categories comprises at least one of: a likely category, a within reach category, and an out of reach category.

9. The method of claim 5, wherein determining the college signature for the college further comprises:
determining, a demographic pattern for the college based on the college data of the college.

10. The method of claim 5, wherein generating the admission score of the student for the college comprises:
calculating a student score of the student based on the student profile data and the weight of each of the one or more admission criteria for the college;
generating the admission score of the student for the college based on an aggregation of the student score for each of the one or more admission criteria for the college.

11. The method of claim 9, wherein generating the admission score of the student for the college comprises:
comparing demographic data of the student with the demographic pattern for the college.

12. The method of claim 1, wherein training of the machine learning module comprises:
obtaining training admissions data, wherein the training admissions data comprises training college data and training student data;
processing the training admissions data using the machine learning module, wherein the processing of the training admissions data comprises determining a plurality of training admission criteria, training weights and training student scores; and
based on the processing, generating one or more training recommendation lists.

13. A system, comprising:
a memory configured to store computer executable instructions; and
one or more processors configured to execute the instructions to:
receive student profile data of a student;
obtain college data associated with each of a plurality of colleges;
determine, using a trained machine learning module, a college signature for each of the plurality of colleges based on the respective college data, wherein the college signature comprises one or more admission criteria and a weight associated with each of the one or more admission criteria;
generate, using the trained machine learning module, an admission score corresponding to each of the plurality of colleges for the student, based on a comparison between the student profile data and the college signature for each of the plurality of colleges; and
generate a list of recommended colleges for the student based on the admission score of the student corresponding to each of the plurality of colleges.

14. The system of claim 13, wherein to determine the college signature for a college from the plurality of colleges, the one or more processors are configured to:
determine one or more admission criteria for the college based on the college data;
analyze the accepted student profile data and the rejected student profile data of the college to assign a weight to each of the one or more admission criteria for the college;
calculate a weighted admission score for each profile of the accepted student profile data and the rejected student profile data based on the assigned weight for each of the one or more of admission criteria, the accepted student profile data, and the rejected student profile data; and
calculate a threshold score for the college, based on the weighted admission score of each profile from the accepted student profile data and the rejected student profile data.

15. The system of claim 14, wherein to generate the list of recommended colleges for the student, the one or more processors are configured to:
compare the admission score of the student for the college with the threshold score for the college;
assign a category from a plurality of categories to the college for the student based on the comparison; and
generate the list of recommended colleges for the student based on the assigned category to the college for the student.

16. The system of claim 15, wherein to generate the list of recommended colleges for the student, the one or more processors are configured to:
select one or more colleges from the plurality of colleges based on an assigned category for each of the plurality of colleges for the student, wherein the category is assigned to each of the plurality of colleges based on a comparison between admission score of the student for the college with corresponding the threshold score for the college; and
generate the list of recommended colleges for the student based on the selected one or more colleges; and
render for display the list of recommended colleges for the student and one or more graphical user interface elements selectable by a user to apply for admission.

17. The system of claim 14, wherein to generate the admission score of the student for the college, the one or more processors are configured to:
calculate a student score of the student based on the student profile data and the weight of each of the one or more admission criteria for the college;
generate the admission score of the student for the college based on an aggregation of the student score for each of the one or more admission criteria for the college.

18. The system of claim 13, wherein to train the machine learning module. the one or more processors are configured to:
obtain training admissions data, wherein the training admissions data comprises training college data and training student data;
process the training admissions data using the machine learning module, wherein the processing of the training admissions data comprises determining a plurality of training admission criteria, training weights and training student scores; and based on the processing, generate one or more training recommendation lists.

19. A computer programmable product comprising a non-transitory computer readable medium having stored thereon computer executable instructions, which when executed by one or more processors, cause the one or more processors to carry out operations comprising:
receiving student profile data of a student;
obtaining college data associated with each of a plurality of colleges;
determining, using a trained machine learning module, a college signature for each of the plurality of colleges based on the respective college data, wherein the college signature comprises one or more admission criteria, and a weight associated with each of the one or more admission criteria;
generating, using the trained machine learning module, an admission score corresponding to each of the plurality of colleges for the student, based on a comparison between the student profile data and the college signature for each of the plurality of colleges; and
generating a list of recommended colleges for the student based on the admission score of the student corresponding to each of the plurality of colleges.

20. The computer programmable product of claim 19, the operations further comprising:
determining one or more admission criteria for the college based on the college data;
analyzing the accepted student profile data and the rejected student profile data of the college to assign a weight to each of the one or more admission criteria for the college;
calculating a weighted admission score for each profile of the accepted student profile data and the rejected student profile data based on the assigned weight for each of the one or more of admission criteria, the accepted student profile data, and the rejected student profile data; and
calculating a threshold score for the college, based on the weighted admission score of each profile from the accepted student profile data and the rejected student profile data.
